(19) United States
(12) Patent Application Publication
(10) Pub. No.: US 2026/0359899 A1
(43) Pub. Date: Nov. 12, 2026

(54) SYSTEM AND METHOD FOR REAL-TIME RISK CLASSIFICATION USING NEURAL NETWORK ANALYSIS OF STREAMING WEARABLE DATA AND NATURAL LANGUAGE PROCESSING OF MEDICAL RECORDS

(71) Applicant: SecondOpinionExpert, Inc., Westlake Village, CA (US)

(72) Inventors: Mohan ANANDA, Westlake Village, CA (US); Gor GALSTYAN, West Hollywood, CA (US); Paul J. PICHIE, Thousand Oaks, CA (US)

(21) Appl. No.: 19/672,643

(22) Filed: May 9, 2026

Related U.S. Application Data
(60) Provisional application No. 63/803,466, filed on May 9, 2025.

(51) Int. Cl. G06Q 40/08

(52) U.S. Cl. CPC G06Q 40/09; G06Q 40/0822

(57) ABSTRACT

System for dynamic risk classification comprises a communication interface configured to communicatively couple with wearable devices and insurance carrier systems, a data pre-processing module configured to convert unstructured medical records into structured feature vectors using natural language processing including tokenization and named entity recognition, and an artificial intelligence engine comprising a trained neural network. The artificial intelligence engine employs deep learning, natural language processing, and predictive analytics to parse structured and unstructured medical data, and may implement neural network architectures including recurrent neural networks, convolutional neural networks, and transformer-based models. A wearable data collector continuously receives real-time health data streams and compares the data against predefined threshold values to trigger recalculation of risk classifications. In response to a risk classification indicating high-risk status, a risk diversion module automatically generates and transmits routing signals comprising application programming interface calls to insurance carrier systems to initiate underwriting workflows at alternate underwriting entities.

### CROSS-REFERENCE TO RELATED APPLICATIONS

This application claims priority to U.S. Application No. 63/803,466, titled TOOLS PROVIDING INSURABILITY EVALUATION OF AN INDIVIDUAL THROUGH ARTIFICIAL INTELLIGENCE PROCESSING OF MEDICAL RECORDS AND TAILORED QUESTIONNAIRES, filed May 9, 2025, which is hereby incorporated by reference in its entirety.

### INTRODUCTION

Insurance underwriting is a process where insurance companies evaluate a prospective client's risk to determine whether to offer coverage and at what price. Insurance underwriting involves gathering information, assessing risk factors, and deciding whether to accept or decline an application and setting the policy's premium.

Systems may be used for underwriting and evaluating insurance applicants using historical and static data such as medical history, claims data, and predefined actuarial tables. Such platforms may apply rules-based engines for risk classification.

Various regulations and rising demand for personalized insurance products have accelerated the desire for privacy-compliant systems capable of real-time, multidimensional data analysis. However, the lack of scalable, modular APIs may hinder the application of dynamic risk tools within legacy underwriting systems. Therefore, improved systems and methods to address at least one or more of these shortcomings in the art are desired.

### SUMMARY

The following presents a simplified summary of one or more aspects in order to provide a basic understanding of such aspects. The summary is not an extensive overview of all contemplated aspects and neither identifies key or critical elements of all aspects nor delineates the scope of any or all aspects. Its sole purpose is to present some concepts of one or more aspects in a simplified form as an introduction to the more detailed description that is presented later.

Aspects presented here provide tools that are readily accessible to provide a more accurate evaluation of insurability that includes an evaluation of increasing complexity of medical information, maintains individual privacy controls, and meets the demand for more efficient turnaround times in providing insurability evaluation information.

In some aspects, a method and system for dynamic risk classification comprise a communication interface configured to communicatively couple with wearable devices and insurance carrier systems, a data pre-processing module configured to convert unstructured medical records into structured feature vectors using natural language processing including tokenization and named entity recognition, and an artificial intelligence engine comprising a trained neural network. The artificial intelligence engine employs deep learning, natural language processing, and predictive analytics to parse structured and unstructured medical data, and may implement neural network architectures including recurrent neural networks, convolutional neural networks, and transformer-based models. A wearable data collector continuously receives real-time health data streams and compares the data against predefined threshold values to trigger recalculation of risk classifications. In response to a risk classification indicating high-risk status, a risk diversion module automatically generates and transmits routing signals comprising application programming interface calls to insurance carrier systems to initiate underwriting workflows at alternate underwriting entities.

Methods, systems, apparatuses, and computer-readable media are presented herein for a system that provides access to artificial intelligence (AI) based evaluation of insurability of individuals based on input and processing of medical records, wearable device data, and responses to dynamically tailored questionnaires. The system incorporates high-risk insurance models, risk diversion pathways, and contextual wellness strategies to deliver a comprehensive, real-time, and adaptive risk assessment platform. The system fosters transparency and collaboration among stakeholders including insurers, brokers, and applicants, while promoting preventative health measures and personalized risk mitigation.

The foregoing general description of the illustrative embodiments and the following detailed description thereof are merely exemplary aspects of the teachings of this disclosure and are not restrictive. Additional advantages and novel features of aspects of the present invention will be set forth in part in the description that follows, and in part will become more apparent to those skilled in the art upon examination of the following or upon learning by practice thereof.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a diagram illustrating example aspects of an insurability evaluation system, in accordance with various aspects of the present disclosure.

FIG. 2 illustrates an example exchange of data and communication between one or more users and a insurability evaluation system, in accordance with various aspects of the present disclosure.

FIG. 3 is a flowchart illustrating a method for automatically generating and reporting an insurability evaluation using a trained model, in accordance with various aspects of the present disclosure.

FIG. 4 is a block diagram of a computer system on which the disclosed system and method can be implemented, in accordance with various aspects of the present disclosure.

FIG. 5 illustrates an example network environment in which the insurability evaluation system may be implemented, in accordance with various aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

An individual may seek various types of insurance coverage. As well, various different insurance products and insurance providers may provide the type of coverage sought by the individual. Systems may be used for underwriting and evaluating insurance applicants using historical and static data such as medical history, claims data, and predefined actuarial tables. Such platforms may apply rules-based engines for risk classification.

Insurance underwriting is a process where insurance companies evaluate a prospective client's risk to determine whether to offer coverage and at what price. Insurance underwriting involves gathering information, assessing risk factors, and deciding whether to accept or decline an application and setting the policy's premium.

A representative may first collect data from an applicant's application, such as personal details and medical information, among other examples. Then, an underwriter may analyze the collected information to assess risks associated with insuring the applicant. An underwriting may consider various factors, such as the applicant's age, gender, health history, family medical history, occupation, and/or lifestyle. For life insurance products, an underwriter may consider factors such as life expectancy. Then, based on the risk assessment, the underwriter may decide whether to accept the application and/or different types of policies or coverage options, depending on the assessed risk. The underwriter may identify a cost, or insurance premium, based on the perceived risk. Applicants for which a higher risk is identified may be associated with higher insurance premiums. There may be different levels or categories, each having a corresponding premium. The underwriter may determine additional terms and conditions for a policy, such as deductibles and/or coverage limits. The underwriter may use actuarial data and software tools to identify the likelihood and magnitude of potential claims, as part of determining whether, and at what cost, to offer insurance coverage.

Underwriting and evaluating insurance applicants may use historical and static data such as medical history, claims data, and predefined actuarial tables. Such platforms may apply rules-based engines for risk classification. However, such systems provide a one-time risk score or assessment rather than a dynamic evaluation. Additionally, systems could benefit from consideration of lifestyle, social, and/or behavioral determinants dynamically. Systems may have a limited capability for continuous monitoring or interaction with the insured individual and/or may lack a direct mechanism for redirecting high-risk profiles to specialized insurers. Furthermore, use of generic models lack real-time customization miss considerations based on ongoing behavior and wellbeing. Systems designed for a single insurance product type lack adaptability for multiple lines and/or may be hardcoded for a specific carrier's rules, limiting multi-carrier comparisons or recommendations.

Emerging regulations and rising demand for personalized insurance products have accelerated the need for privacy-compliant systems capable of real-time, multidimensional data analysis. However, the lack of scalable, modular APIs continues to hinder the application of dynamic risk tools within legacy underwriting systems. Aspects presented herein provide a privacy-compliant AI based system capable of real-time, multidimensional data analysis both for single-carrier assessment and comparative evaluations across insurers.

Aspects presented here provide tools that are readily accessible to provide a more accurate evaluation of insurability that includes an evaluation of increasing complexity of medical information, maintains individual privacy controls, and meets the demand for more efficient turnaround times in providing insurability evaluation information.

The present disclosure provides technical improvements over conventional insurability evaluation systems. The data pre-processing module employs natural language processing techniques including tokenization and named entity recognition to convert unstructured medical records into structured feature vectors, enabling more accurate extraction of health-relevant information than keyword-based approaches. The artificial intelligence engine comprising a trained neural network generates embedding vectors from the health metrics that capture complex relationships between health indicators, providing more accurate risk classifications than rule-based systems. The wearable data collector continuously receives real-time health data streams and compares the streamed data against predefined threshold values, triggering automatic recalculation of risk classifications when thresholds are exceeded. This real-time updating capability ensures that risk classifications reflect an applicant's current health status rather than outdated point-in-time measurements. The risk diversion module automatically generates and transmits routing signals comprising application programming interface calls to insurance carrier systems, eliminating manual intervention and reducing latency in the underwriting workflow. These technical improvements result in faster processing times, more accurate risk classifications, and automated carrier routing that reduces human error and delays.

Methods, systems, apparatuses, and computer-readable media are presented herein for a system that provides access to artificial intelligence (AI) based evaluation of insurability of individuals based on input and processing of medical records, wearable device data, and responses to dynamically tailored questionnaires. The system incorporates high-risk insurance models, risk diversion pathways, and contextual wellness strategies to deliver a comprehensive, real-time, and adaptive risk assessment platform. The system fosters transparency and collaboration among stakeholders including insurers, brokers, and applicants, while promoting preventative health measures and personalized risk mitigation.

Aspects presented herein provide a user with an AI based evaluation of the insurability of individuals by processing any combination of electronic medical records (EMRs), claims data, genomic indicators, wearable device data, and/or responses to dynamically tailored questionnaires. The system incorporates high-risk insurance models, risk diversion pathways, and contextual wellness strategies to deliver a comprehensive, real-time, and adaptive risk assessment platform. Aspects presented herein further enable predictive modeling across multiple insurance product types including life, health, disability, and long-term care. The system provided herein fosters transparency and collaboration among stakeholders, e.g., including insurers, brokers, and applicants, while promoting preventative health measures and personalized risk mitigation.

Aspects provided herein meet needs for providing real-time, context-aware wellness feedback. Aspects provided herein enable adaptive questions and answers with medical records for precision modeling. Aspects presented herein enable dynamic re-routing of high-risk applicants to specialized insurers. The aspects presented herein provide a shared platform with active monitoring and real-time adjustments.

Rather than a static analysis, that includes a one-time risk score or assessment, the aspects presented herein provide a dynamic evaluation and wellness recommendations relating to target insurability. As well, where other systems lack behavioral context, the system presented herein considers lifestyle, social, and/or behavioral determinants dynamically. Aspects presented herein provide a feedback look that provides a capability for continuous monitoring or interaction with the insured individual. Aspects presented herein provide a risk diversion framework that includes a direct mechanism for redirecting high-risk profiles to specialized insurers. Whereas other systems use generic models with limited personalization, the aspects presented herein provide a system with real-time customization based on ongoing behavior and wellbeing. As well, aspects presented herein provide cross-product application. Rather than a design for a single insurance product type, the aspects presented herein provide adaptability for multiple lines of insurance product types (e.g., term life vs. long-term care). In addition, whereas a platform may be hardcoded for a specific carrier’s rules with carrier-specific inflexibility, the aspects presented herein provide multi-carrier comparisons and/or recommendations.

Aspects presented herein provide a novel approach to insurability evaluation, focusing on any of dynamic risk profiling, risk aversion models, contextual risk mitigation, real-time monitoring and reassessment, and/or stakeholder engagement.

As an example, for dynamic risk profiling, the system includes an AI-driven analysis of medical records, wearable device metrics, and individualized questionnaires. Risk diversion models can be used to automatically reroute, and connect, applicants categorized as high-risk to specialized underwriters or reinsurance entities. Conceptual risk mitigation is provided through personalized wellbeing insights and prevention strategies. The system allows for real-time monitoring and reassessment, e.g., via wearables, apps, and/or cloud integration. Aspects provide for stakeholder engagement through a shared platform allowing brokers, underwriters, and applicants to interact with the risk score and wellness feedback in a transparent, secure manner.

The system may further allow for integration and use of genomic data and pharmacogenomics, e.g., when available, to enhance an accuracy in risk modeling for longevity, critical illness, and/or medication compatibility. The system may provide simulation data (e.g., such as inclusion of a digital twin simulation for an applicant) to forecast how lifestyle modifications could improve insurability over time. The system may include embedded consent-management and disclosure tools to streamline user authorization for third-party data access and improve auditability for compliance. The system addresses privacy concerns, as all patient data is anonymized and processed in a secure environment, complying with regulations such as Health Insurance Portability and Accountability Act (HIPAA).

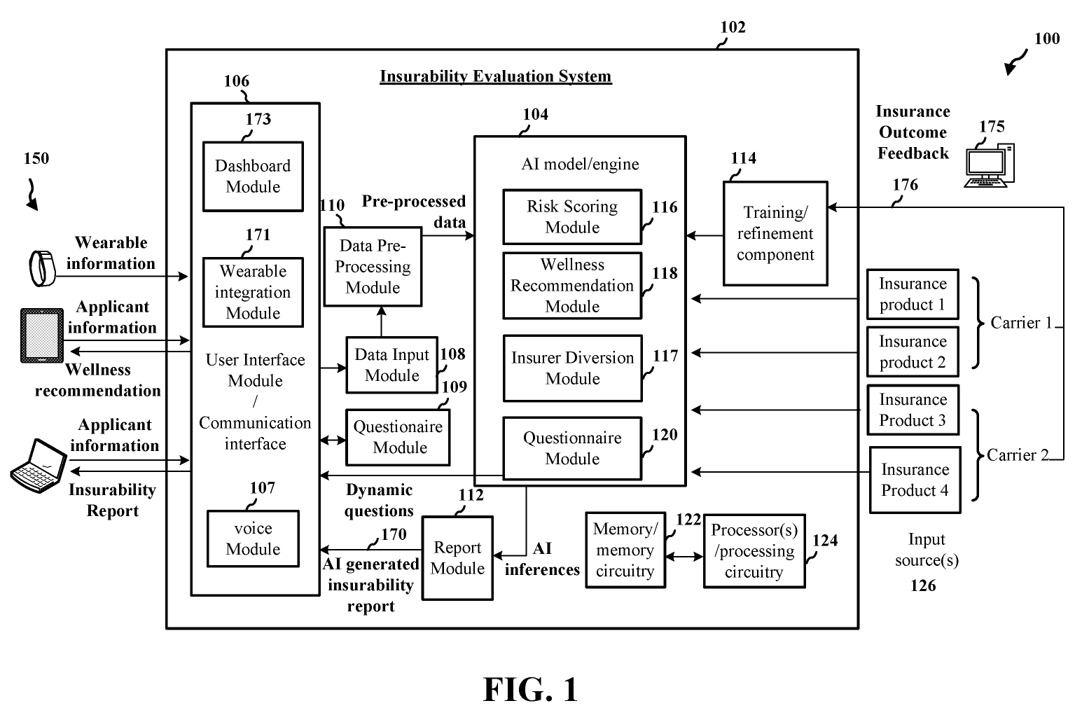

FIG. 1 illustrates an example diagram 100 that includes an insurability evaluation system 102 that includes an AI engine 104 that employs deep learning, natural language processing (NLP), and predictive analytics to parse structured and unstructured medical data.

As an example, the AI engine 104 may employ deep learning, natural language processing (NLP), and predictive analytics to parse structured and unstructured medical data. In some aspects, the AI engine 104 may implement various neural network architectures including recurrent neural networks (RNNs) for processing sequential health data, convolutional neural networks (CNNs) for pattern recognition in medical imaging or structured health records, and transformer-based models for natural language understanding of clinical notes and medical documentation. The deep learning components of the AI engine 104 extract hierarchical feature representations from raw health data, enabling the system to identify complex patterns that correlate with insurance risk without requiring manual feature engineering. The NLP components parse unstructured medical text including physician notes, diagnostic reports, and prescription records to extract clinically relevant information that informs the risk classification. The predictive analytics components of the AI engine 104 forecast future health trajectories based on historical health data and real-time wearable data streams, enabling proactive risk assessment that anticipates changes in an applicant's health status. In some aspects, the AI engine 104 may employ long short-term memory (LSTM) networks or gated recurrent units (GRUs) to analyze temporal patterns in streaming health data from wearable devices, capturing trends and anomalies in heart rate, activity levels, and other continuously monitored health metrics. The combination of deep learning, NLP, and predictive analytics enables the AI engine 104 to generate dynamic risk classifications that adapt in real-time to changes in an applicant's health profile, providing a technical improvement over static rule-based systems that cannot process unstructured data or adapt to evolving health conditions.

As illustrated, the insurability evaluation system 102 may include memory 122 (or memory circuitry) and one or more processors 124 (or processor circuitry) configured to cause a computer system to perform the aspects described in connection with the use of the medical opinion system, as described herein.

The insurability evaluation system 102 includes a data input module 108 that is configured to receive, or collect, all relevant applicant information in order to provide an insurability evaluation and/or recommendation to the user. For example, the data input module 108 receives, or collects, an applicant’s health information. The user data may be received from individual applicants and/or from a user (e.g., 204) via a user device 150. In some aspects, the user device may be a wearable.

The insurability evaluation system 102 may include a user interface module 106 that provides a user interface having one or more entry components for users to enter their information. For example, the communication interface may provide for communication between the user device 150 and the insurability evaluation system 102 over a network. For example, the user interface may include one or more entry components that allow a user to type or enter text or make selections via a drop down box.

In some aspects, the insurability evaluation system 102 may include a voice module 107 or voice interface (e.g., as part of a user interface or communication interface) that is configured to receive voice entry of data. For example, a user may vocally describe their applicant information. The voice module 107 may receive the spoken description and convert the description to text and/or process the vocal description for entry to the AI engine 104. A user may enter additional health information, health history information, family history, and/or test result information via an entry component that may allow the user to enter text, select from a set of options, vocally describe information, and/or upload or link files. In some aspects, the user interface may include an entry component that enables a user to upload files or to link files/records for the user.

Any document that is uploaded, or transmitted electronically to the system, will remain confidential and the system will not reveal it to anyone other than necessary for the insurance evaluation. The documents may be encrypted or may be automatically deleted after the evaluation is complete.

The insurability evaluation system 102 includes a questionnaire module (e.g. 109 and/or 120) that is configured to dynamically generate health-related questions based on user profile, prior answers, and risk factors. The generation is dynamic, as the questions presented to, or about, the applicant dynamically vary as applicant information is received. In some aspects, the questionnaire module 120 may be included a part of the AI engine 104 and may use AI/ML model processing to dynamically output an ongoing set of questions for the applicant in order to assess insurability.

The user interface may include a wearable integration module 171 that establishes a connection with one or more wearable devices. For example, wearable devices includes electronic devices designed to be worn on or near the body and include sensors, processors, and connectivity features to collect, process, and transmit data, relating health and fitness tracking metrics. Examples include smart watches, fitness trackers, glucose meters, among other examples. The wearables may collect data such as heart rate, physical activity metrics, or sleep pattern information, among other examples. The wearable integration module is configured to receive real-time health data for an applicant.

The system 102 includes a risk scoring engine 116, e.g., which may be referred to as an insurability module) that calculates an insurability score based on medical, behavioral, genetic, and/or contextual inputs. In some aspects, the risk scoring engine (e.g., 116) may incorporate longitudinal data trends to model future insurability under various behavioral scenarios.

In response to the risk classification indicating a high-risk status, the risk diversion module automatically generates routing signals without requiring human intervention. The routing signals comprise application programming interface calls that are transmitted to insurance carrier systems via the communication interface. Upon receipt of the routing signals, the insurance carrier systems automatically initiate an underwriting workflow at an alternate underwriting entity. This automated routing eliminates the delays associated with manual review and ensures consistent application of routing rules across all applicants.

The system 102 includes a wellness module 118 that is configured to provides health tips and preventive actions tailored to user’s profile. In some aspects, the system may include a gamification engine to encourage participation and track engagement with wellness suggestions.

The system 102 may include an insurer diversion module 117 that identifies and outputs one or more suggestions for alternate underwriting pathways for high-risk individuals.

The system 102 may include a stakeholder dashboard 173 that allows real-time access to relevant risk metrics for insurers, brokers, and applicants via a user interface that enables each of the stakeholders to visually view various output from the AI engine, e.g., which may dynamically change as additional information is input for the applicant. In some aspects, the system may allow for anonymized benchmarking across cohorts for underwriting teams.

The user interface module 106 may also be designed to present AI generated reports, as shown at 170, which may be automatically formatted and provided to the communication interface via a report module 112.. The user interface module 106 may support multiple input formats such as Electronic Health Records (EHR), PDFs, and/or direct inputs from wearable devices. The user interface module 106 may comprise, or be comprised in, a communication interface that is configured to enable the exchange of communication via a communication path (e.g., whether a wired path, a cable path, a fiber optic path, a wireless link, and/or other communication channel between computer systems) between a user device 150 and the medical opinion system. In some aspects, the medical opinion system may be provided at a remote server that communicates with the user devices via the internet, e.g., such as described in connection with FIG. 7.

The insurability evaluation system 102 may include a pre-processing module 110 that processes raw input data from data input module to prepare the data to be input to the AI engine 104. For example, the pre-processing module 110 may process the raw input data using NLP techniques and/or data normalization to prepare the data to be used as input to the AI engine 104. The applicant information, may be processed to translate the records into a structured format that is compatible with the AI engine 104. In some aspects, the pre-processing module 110 may be configured to process vocal description spoken by the user to obtain the relevant description for assessment by the AI engine 104. The pre-processing module 110 may then structure the information from the relevant description into a format that is compatible with the AI engine 104. The pre-processing module 110 may remove or filter irrelevant data before inputting the processed data to the AI engine 104. In some aspects, the pre-processing module 110 may anonymize patient identifiers to ensure patient privacy as the patient information is input to the AI engine 104. The system is a web-based HIPAA compliant and secure system that allows applicants a convenient way to register and upload their information. The system is designed to ensure compliance with the HIPAA encryption standards to ensure the security and privacy of an individual's Protected Health Information (PHI). The system will be updated to support new standards issued by the National Institute of Standards and Technology (NIST) regarding the HIPAA encryption standards. Aspects may include establishing a secure connection and/or performing a HIPAA security check. The system is a web-based HIPAA compliant and secure system that allows patients a convenient way to register and upload their information. The system is designed to ensure compliance with the HIPAA encryption standards to ensure the security and privacy of an individual's Protected Health Information (PHI). The system will be updated to support new standards issued by the National Institute of Standards and Technology (NIST) regarding the HIPAA encryption standards.

The system may receive feedback, at 176, can be used to refine the AI/ML model or algorithms of the AI engine 104, e.g., based on various input sources 126 of feedback information, e.g., from various devices 175. The feedback may be received relating to various insurance metrics based on outcome for prior AI generated insurability evaluations.

The AI engine 104 may be built on machine learning algorithms, including deep learning and/or natural language processing. For example, the AI engine 104 may use an AI program that includes a machine learning model or an artificial neural network (ANN) model. The AI engine 104 may include a trained AI model that is trained on a vast dataset of medical information, insurance outcomes, risk assessments, and/or guidelines to make inferences based on applicant information that is input by the pre-processing module 110 according to patterns or relationships determined in the data input to the AI engine 104. An inference can refer to an output of the AI engine corresponding to a determination, a prediction, an identification, a decision, a recommendation, or a value. For example, based on pattern(s) or relationship(s) identified in the applicant information that is input to the AI engine, the AI engine 104 outputs an inference for one of more of an insurability assessment relating to potential insurance products and/or rates and/or recommendations to expand the product options or reduce premiums associated with such products. An ML model may include unsupervised learning, supervised learning, and/or semi-supervised learning. Terms such “AI engine,” “ML engine,” AI/ML engine,” “AI/ML model,” “ML model,” “trained ML model,” “ANN,” “model,” “algorithm,” etc. may be used interchangeably.

In some aspects, the AI engine 104 may use any of machine-learning algorithms, deep-learning algorithms, neural networks, reinforcement learning, regression, boosting, and/or advanced signal processing methods for insurability evaluations.

Reinforcement learning is a type of machine learning that involves the concept of taking actions in an environment in order to maximize a reward. Reinforcement learning is a machine learning paradigm. Other paradigms include supervised learning and unsupervised learning. Basic reinforcement may be modeled as a Markov decision process (MDP) with a set of environment states and agent states, as well as a set of actions of the agent. A determination may be made about a likelihood of a state transition based on an action and a reward after the transition. The action selection by an agent may be modeled as a policy. The reinforcement learning may enable the agent to learn an optimal, or nearly-optimal, policy that maximizes a reward. Supervised learning may include learning a function that maps an input to an output based on example input-output pairs, which may be inferred from a set of training data, which may be referred to as training examples. The supervised learning algorithm analyzes the training data and provides an algorithm to map to new examples.

Regression analysis may include statistical analysis to estimate the relationships between a dependent variable (e.g., an outcome variable) and one or more independent variables. Linear regression is an example of a regression analysis. Non-linear regression models may also be used. Regression analysis may include estimating, or determining, relationships of cause between variables in a dataset.

Boosting includes one or more algorithms for reducing variance or bias in supervised learning. Boosting may include iterative learning based on weak classifiers (e.g., that are somewhat correlated with a true classification) with respect to a distribution that is added to a strong classifier (e.g., that is more closely correlated with the true classification) in order to convert weak classifiers to stronger classifiers. The data weights may be readjusted through the process, e.g., related to accuracy.

Among others, examples of machine learning models or neural networks that may be included in the AI engine 104 include, for example, artificial neural networks (ANN); decision tree learning; convolutional neural networks (CNNs); recurrent neural networks (RNNs), deep learning architectures in which an output of a first layer of neurons becomes an input to a second layer of neurons; support vector machines (SVM), e.g., including a separating hyperplane (e.g., decision boundary) that categorizes data; regression analysis; diffusion models; large language models (LLMs); Bayesian networks; genetic algorithms; deep convolutional networks (DCNs) configured with additional pooling and normalization layers; and/or deep belief networks (DBNs).

In some aspects, the AI engine 104 may include an ANN with interconnected group of artificial neurons (e.g., neuron models) as nodes. Neuron model connections may be modeled as weights, in some aspects. The AI engine 104 may provide predictive modeling, adaptive control, and other applications through training via a dataset relating to medical research, clinical guidelines, medical literature, medical records and corresponding outcomes. In some aspects, the AI engine 104 may include a non-linear statistical data model and/or a decision making model. Machine learning may model complex relationships between input data and output information.

The AI engine 104 may include multiple layers and/or operations that may be formed by concatenation of one or more of the referenced operations. Examples of operations that may be involved include extraction of various features of data, convolution operations, fully connected operations that may be activated or deactivated, compression, decompression, quantization, flattening, etc. The term layer may indicate an operation on input data. Weights, biases, coefficients, and operations may be adjusted in order to achieve an output closer to the target output. Weights and biases are examples of parameters of a trained machine learning model. Different layers of a machine learning model may be trained separately.

A variety of connectivity patterns, e.g., including any of feed-forward networks, hierarchical layers, recurrent architectures, feedback connections, etc., may be included in a machine learning model. Layer connections may be fully connected or locally connected. For a fully connected network, a first layer neuron may communicate an output to each neuron in a second layer. Each neuron in the second layer may receive input from each neuron in the first layer. For a locally connected network, a first layer neuron may be connected to a subset of neurons in the second layer, rather than to each neuron of the second layer. A convolutional network may be locally connected and may be configured with shared connection strengths associated with the inputs for each neuron in the second layer. In a locally connected layer of a network, each neuron in a layer may have the same, or a similar, connectivity pattern, yet having different connection strengths. Aspects of the AI engine 104 may be implemented in various types of processing circuits along with memory and corresponding instruction or code. For example, the AI engine 104 may be implemented via one or more hardware circuits, such as, such as one or more central processing units (CPUs), and/or one or more graphics processing units (GPUs). The AI engine and/or various modules of the AI engine 104 may be stored in memory (e.g., 122) and may be accessible to one or more processors 124 to cause the processors to perform the aspects described in connection with the insurability evaluation system 102.

The training of the AI engine 104 may be performed initially, and/or in an ongoing manner, by a training component 114. The AI engine 104 may be trained, e.g., with supervised learning, unsupervised learning, semi-supervised learning, and/or reinforcement learning. The training component 114 may be configured to provide the training or that facilitates the training of the AI engine 104. During training, the AI engine 104 may be presented with an input of training applicant information that the AI engine 104 uses to compute to produce an output of an inferred insurability recommendation, insurer diversion recommendation, dynamic questionnaire output, and/or wellness recommendation. The actual output may be compared to a target output and the difference may be used to adjust parameters (e.g., weights, biases, coefficients, etc.) of the AI/ML model in order to provide an output closer to the target output. Before training, the output may not be correct or may be less accurate. A difference between the output and the target output, may be used to adjust weights of a machine learning model to align the output is more closely with the target, e.g., insurability evaluations.

A learning algorithm may calculate a gradient vector for adjustment of the weights. The gradient may indicate an amount by which the difference between the output and the target output would increase or decrease if the weight were adjusted. The weights, biases, or coefficients of the model may be adjusted until an achievable error rate stops decreasing or until the error rate has reached a target level.

The training data may be collected, or input, for the training component 114 to use to train the AI engine 104.

In some aspects, the training component 114 may receive, gather, and/or collect training data in an ongoing manner. Therefore, the training of the AI engine 104 may continue to improve and/or remain current according to feedback received from multiple insurance carriers and/or for multiple products. In some aspects, the training component 114 may continuously receive such input data. In some aspects, the training component 114 may periodically receive or gather the input data for training the AI engine 104. The input data for training may be collected online and/or offline to further train, refine, prune, and/or optimize the algorithms of the AI/engine 104.

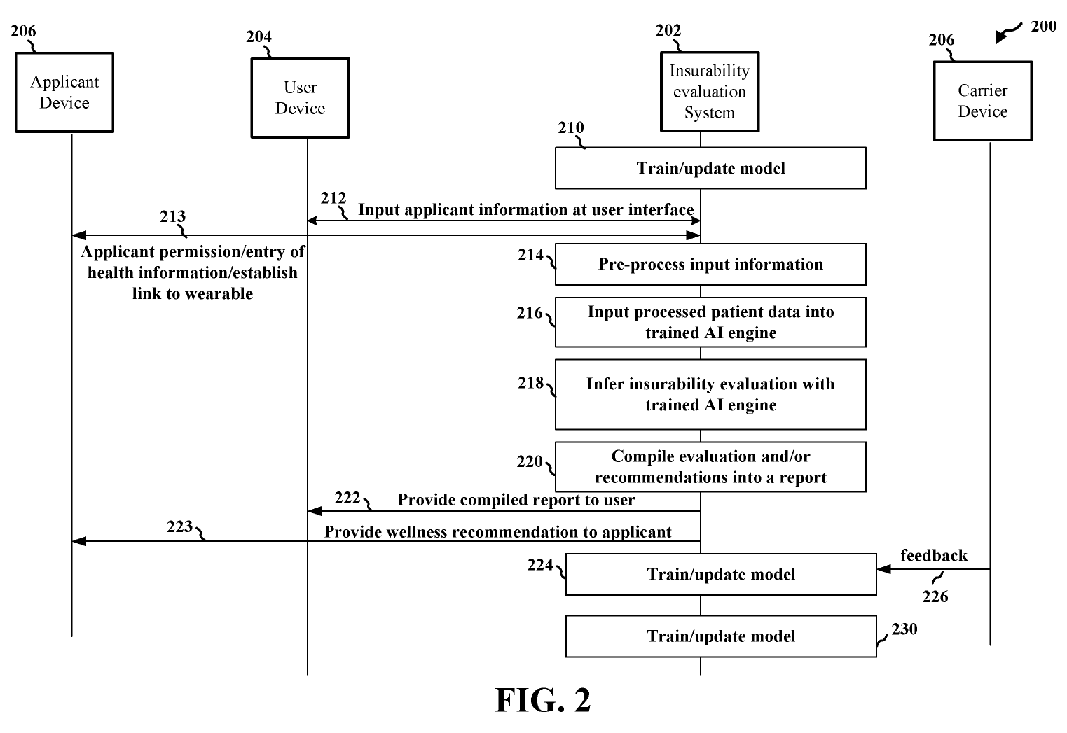

FIG. 2 is a communication flow 200 between an insurability evaluation system 202 (e.g., which may include one or more aspects of the insurability evaluation system 102 in FIG. 1), a user 204 and/or an applicant 206 that interacts with the insurability evaluation system 202 via a user interface, such as described in connection with FIG. 1. In some aspects, the user 204 may be an insurance professional that collects applicant information and provides an evaluation of insurance options to the applicant. In some aspects, the user may be an applicant themselves. The insurability evaluation system 202 may include a trained AI/ML model, such as described in connection with the AI engine 104. FIG. 2 shows that the insurability evaluation system 202 may train or update the AI/ML model, or AI/ML algorithms, at 210. The training may be performed based on any combination of historical applicant information, and/or historical insurance product information and outcomes, among other examples.

The trained neural network is trained using backpropagation and gradient descent optimization on a dataset of anonymized insurance outcomes and medical records to minimize a loss function. During inference, the neural network receives the structured feature vectors generated by the data pre-processing module and generates embedding vectors that represent the applicant's health metrics in a multi-dimensional feature space. The neural network outputs a risk classification based on the embedding vectors. When the wearable data collector receives real-time health data that exceeds predefined threshold values, the artificial intelligence engine recalculates the risk classification using the updated health data, dynamically updating the embedding vectors and outputting an updated risk classification. This continuous feedback loop enables the system to maintain accurate risk classifications as an applicant's health status changes over time.

Once the AI engine is trained, an applicant user, e.g., 206, can register and consents to data use, e.g., as shown at 213. In some aspects, a user 204 may initiate entry of applicant information at 212, which may trigger the system to communicate with the applicant 206 to obtain medical or health information and/or to receive consent to obtain such information. In some aspects, at 212, the applicant may establish a link or otherwise provide health metric information from one or more wearables, such as a stream of health data that is provided to the insurability evaluation system platform. The system 202 may import medical records via APIs and EHR integrations, e.g., based on the permission or consent provided at 213. In some aspects, the applicant may enter or upload documents, test results, imaging, or other health records. As part of the communication exchange at 21 and/or 212, the system 202 may output tailored questions as part of a personalized questionnaire for applicant information. The questions may be provided in a dynamic manner, e.g., selected based on received applicant information in order to provide a targeted insurability analysis via the AI engine.

The input at 212 and/or 213 may be via the user interface module 106 described in connection with FIG. 1, for example. The entry may be as text, selections of options, upload of files, and/or spoken words. At 214, the system 202 may pre-process the input information to structure the received data in a manner to be analyzed by the AI engine. At 216, the pre-processed patient data is input to the AI engine and analyzed based on the trained AI/ML model. At 218, the AI engine may provide various inferences based on the received information. For example, the system 202 evaluates the risk associated with various insurance products for the applicant in real-time and assigns a composite score. If the system determines that the applicant meets high-risk criteria, the user can be matched to a specialized insurer. In some aspects, the evaluation may provide an assessment in connection with one or multiple possible risk tiers. For example, an applicant that is determined to be in a low-risk tier may be indicated to qualify for a standard insurance. An applicant that is determined to be in a moderate risk tier may be provided with health coaching and re-evaluation opportunities. An applicant that is determined to be in a high risk tier may be routed to, or automatically connected to, specialized underwriters or reinsurance solutions. An applicant that is determined to be in a very high risk tier may be routed to guaranteed issue products or receive modified policy structures (e.g., graded benefit policies).

As examples of wellness suggestions that may be provided to the applicant at 223, the applicant may be provided with activity suggestions (e.g., walking, breathing exercises) that may reduce a premium cost identified for the applicant or that may allow the applicant to apply for additional insurance products and/or applicant requested insurance products. A wellness suggestion may include dietary tips based on biomarkers, medication adherence reminders, and/or early warnings for abnormalities. In some aspects, geolocation-based wellness cues may be incorporated (e.g., air quality, UV index, local fitness opportunities) to provide more targeted wellness recommendations. In some aspects, a wellness recommendation may include a predictive prompt ahead of a potential medical deterioration based on pattern recognition (e.g., sleep irregularities before cardiac events).

At 220, the system 202 compiles the assessments and/or recommendations into one or more user reports, e.g., that are provided to the user 204 and/or applicant 206 at 222 and/or 223. The reports may be compiled differently and or more include different information. For example, the compiled report may be displayed to the user 204 or the applicant 206 at the user interface or may be provided in an email, text message, or other manner to the user 204. As described in connection with FIG. 1, recommendations can be reported to improve health and possibly reduce risk over time. Stakeholders can view evolving risk metrics and interact accordingly. Although shown as a single evaluation and report, the applicant may provide ongoing information, such as via wearables or updated input, and an ongoing analysis may be performed. Periodic reports may be provided, or the information may be continuously updated and accessible via a dashboard. In other examples, a report may be triggered when an updated evaluation would provide different insurance options, whether different products or different costs, for an applicant.

In a user uploads or consents to access genomic data, the AI engine can adjust for predispositions (e.g., BRCA, APOE) that impact a risk profile for an applicant. Real-time alerts can be issued to the applicant and, if permitted, to insurance representatives when data thresholds are exceeded (e.g., abnormal heart rhythm, blood oxygen levels, etc.) to assist the applicant in wellness management.

The input of applicant information, the output of the report at 222 and/or the wellness recommendations at 223 may include end-to-end encryption, HIPAA and GDPR compliance, and consent-driven data acquisition. In some aspects, full audits logs may be generated and stored indicating a log of all stakeholder access to user data. The system 202 may include a federated learning architecture to train models without centralizing PII.

The AI engine may continue to receive updated training data and feedback to refine the AI/ML model and improve the inferences output by the AI engine. For example, at 224, the system may train or update the AI/ML of the AI engine based on additional feedback information 226 received from one or more insurance carriers based on prior insurability evaluations and outcomes. The feedback 226 may then be used to update the AI/ML model to further refine the inferences provided by the AI engine of the insurability evaluation system 202. The training and updating may be continuous/repeated, e.g., as shown by 230.

The present disclosure addresses technical limitations of insurance evaluation based on static data or tables through a neural network architecture that enables dynamic risk classification based on continuously received real-time health data. The artificial intelligence engine comprises a trained neural network that analyzes structured feature vectors, questionnaire responses, and real-time health data streams to generate a risk classification. Unlike rule-based systems that apply static decision trees, the trained neural network generates embedding vectors from the health metrics that capture complex, non-linear relationships between health indicators in a multi-dimensional feature space. These embedding vectors enable the neural network to identify subtle patterns in the health data that correlate with insurance risk, providing more accurate risk classifications than conventional approaches. The neural network dynamically updates the risk classification based on the continuously received real-time health data streams, ensuring that the risk classification reflects the applicant's current health status rather than outdated point-in-time measurements.

The data pre-processing module employs natural language processing techniques to convert unstructured medical records into structured feature vectors that enable more accurate analysis by the artificial intelligence engine. The data pre-processing module tokenizes unstructured medical text and applies named entity recognition to extract medical conditions, medications, and procedures from the medical records. This structured extraction enables the neural network to process medical information that would otherwise be inaccessible to automated analysis, such as physician notes, diagnostic reports, and treatment histories. The structured feature vectors generated by the data pre-processing module serve as inputs to the neural network, which generates embedding vectors representing the applicant's health profile in a format suitable for risk classification.

The wearable data collector enables continuous integration of real-time health data into the risk classification process. The wearable data collector continuously receives real-time health data streams from one or more wearable devices via the communication interface. In some aspects, the wearable data collector compares the real-time health data streams against predefined threshold values and triggers the artificial intelligence engine to recalculate the risk classification when the real-time health data streams exceed the predefined threshold values. This threshold-based triggering mechanism ensures that significant changes in an applicant's health status are promptly reflected in the risk classification without requiring continuous recalculation for minor data fluctuations. The continuous feedback loop between the wearable data collector and the artificial intelligence engine enables the system to maintain accurate risk classifications as an applicant's health status changes over time.

The risk diversion module provides automated routing of high-risk applicants to alternate underwriting entities, eliminating manual intervention and reducing latency in the underwriting workflow. In response to the risk classification indicating a high-risk status, the risk diversion module automatically generates and transmits routing signals to one or more insurance carrier systems via the communication interface. In some aspects, the routing signals comprise application programming interface calls that automatically initiate an underwriting workflow at the alternate underwriting entity. This automated routing ensures consistent application of routing rules across all applicants and eliminates the delays associated with manual review by underwriters. The routing signals are transmitted in real-time as the risk classification is updated, enabling immediate response to changes in an applicant's risk status.

The training and refinement of the neural network enables continuous improvement of risk classification accuracy based on actual insurance outcomes. In some aspects, a training module receives insurance outcome feedback from the one or more insurance carrier systems and updates parameters of the trained neural network based on the insurance outcome feedback. The training module may apply backpropagation and gradient descent optimization on a dataset of anonymized insurance outcomes and medical records to minimize a loss function. This feedback loop enables the neural network to learn from the outcomes of prior risk classifications, improving the accuracy of future classifications. The continuous refinement of the neural network based on real-world insurance outcomes provides a technical improvement over static rule-based systems that cannot adapt to changing patterns in insurance risk.

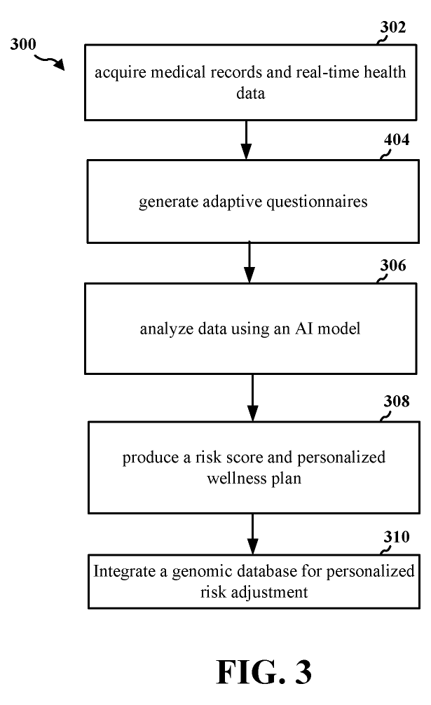

FIG. 3 is a flowchart 300 of a method of automatically generating a insurability evaluation using a trained model. The method may be performed at an insurability evaluation system (e.g., 102, 202). Some aspects of the method may be performed by an AI engine 104 or insurability evaluation component 475 of a processing system that may be part of a medical opinion system.

As shown at 302, the insurability evaluation system receives, via a user interface, medical records and real-time health data for an applicant. For example, the information may be received from a user device 150 via the user interface module 106 of the insurability evaluation system 102. FIG. 2 illustrate examples of acquiring applicant information, at 212 and 213, for example. In some aspects, the acquired information may include real-time wearable data thatis continuously streamed to reassess the risk score dynamically.

At 304, the insurability evaluation system generates adaptive questionnaires. Examples of dynamically adapted questionnaires are described in connection with FIGS. 1 and 2.

At 306, the insurability evaluation system analyzes data using an AI model. Example aspects of the evaluation are described in connection with FIG. 1 and FIG. 2. The AI model may include one or more components of the AI engine 104 in FIG. 1 and/or the insurability evaluation component 475, for example. The AI model may use machine learning algorithms trained on a dataset of anonymized insurance outcomes and medical records. In some aspects, the insurability evaluation system may route individual applicants classified as high-risk to alternate insurers or reinsurance providers. In some aspects, the insurability evaluation system may report a wellness recommendation engine that generates risk-reduction strategies based on real-time and historical data.

At 308, the insurability evaluation system produces a risk score and personalized wellness plan. As described in connection with FIGS. 1 and 2, various aspects of the output may be compiled and reported to the applicant and/or other users.

At 310, the insurability evaluation system may integrate with a genomic database for personalized risk adjustment.

The method may be performed by a system for evaluating insurability that includes an AI engine (e.g., 104) for data analysis, a questionnaire module (e.g., 109), a wearable data collector (e.g., that may include 171), and a stakeholder dashboard (e.g., provided via 106) to view dynamic risk profiles. FIGS. 1 and 2 illustrate example aspects of a system. In some aspects, the system may further include a digital twin simulation module that models future insurability scenarios based on hypothetical user behavior modifications wherein, the simulation engine provides real-time feedback and projected insurability shifts based on inputted or observed lifestyle changes. In some aspects, the system may further include a cross-carrier rules engine that enables comparison of insurability across multiple insurance carriers. In some aspects, the dashboard enables interaction between insurers, brokers, and applicants in real-time. In some aspects, the system may further include a risk diversion module configured to automatically identify and reroute high-risk applicants to alternate underwriting entities.

Aspects may further include systems and methods for generating a personalized risk mitigation plan based on ongoing health monitoring data, questionnaire responses, and evolving medical insights. Example aspects are described in connection with FIGS. 1, 2, and 3.

The aspects presented herein introduce a comprehensive, AI-powered system for real-time risk evaluation, redirection, and mitigation in the insurance domain. In some aspects, by allowing the integration of genomic insights, predictive simulation, and/or cross-carrier comparability, the system presented herein bridges the gap between clinical accuracy, user engagement, and insurance underwriting needs, creating a more efficient and equitable insurability assessment model. The platform represents a unified underwriting interface capable of adapting to evolving insurance products, user behaviors, and regulatory landscapes. For example, where available and authorized, genomic and pharmacogenomic data may be integrated into the insurability modeling process as an optional data layer.

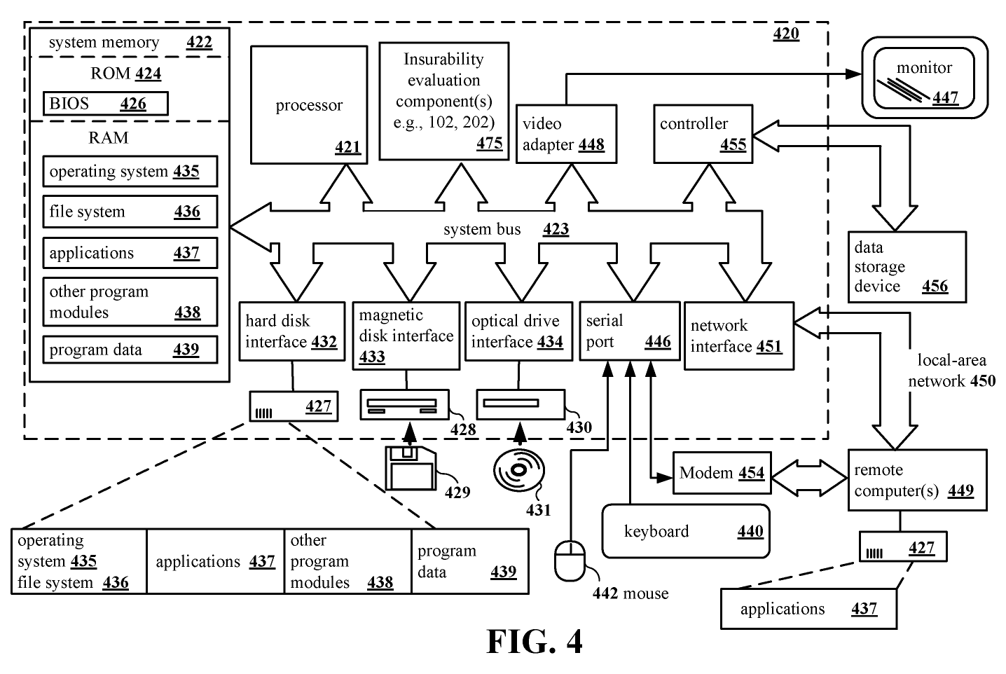

FIG. 4 is a block diagram illustrating a computer system 420 on which aspects of the insurability evaluation system, e.g., as described in connection with any of FIGS. 1-3 may be implemented in accordance with an example aspect. The computer system 420 can correspond to the physical server(s) on which the insurability evaluation service (e.g., 102, 202) is executing. In one configuration, computer system 420 may include one or more modules of a insurability evaluation component(s) 475. The insurability evaluation component(s) 475 and/or the computer system 420, and in particular, the file system 436 and/or the processor (e.g., 421), may be configured to perform the aspects of the flowchart in FIG. 3, and or to perform the aspects described in connection with the insurability evaluation system 102 and/or 202.

As shown, the computer system 420 (which may comprise a personal computer or a server) includes a central processing unit 421, a system memory 422, and a system bus 423 connecting the various system components, including the memory associated with the central processing unit 421. As will be appreciated by those of ordinary skill in the art, the system bus 423 may comprise a bus memory or bus memory controller, a peripheral bus, and a local bus that is able to interact with any other bus architecture. The system memory may include permanent memory (ROM) 424 and random-access memory (RAM) 625. The basic input/output system (BIOS) 426 may store the basic procedures for transfer of information between elements of the computer system 420, such as those at the time of loading the operating system with the use of the ROM 424.

The computer system 420 may also comprise a hard disk 427 for reading and writing data, a magnetic disk drive 428 for reading and writing on removable magnetic disks 429, and an optical drive 430 for reading and writing removable optical disks 431, such as CD-ROM, DVD-ROM and other optical media. The hard disk 427, the magnetic disk drive 428, and the optical drive 430 are connected to the system bus 423 across the hard disk interface 432, the magnetic disk interface 433, and the optical drive interface 434, respectively. The drives and the corresponding computer information media are power-independent modules for storage of computer instructions, data structures, program modules, and other data of the computer system 420.

An example aspect comprises a system that uses a hard disk 427, a removable magnetic disk 429 and a removable optical disk 431 connected to the system bus 423 via the controller 455. Any type of media 456 that is able to store data in a form readable by a computer (solid state drives, flash memory cards, digital disks, random-access memory (RAM) and so on) may also be utilized.

The computer system 420 has a file system 436, in which the operating system 435 may be stored, as well as additional program applications 437, other program modules 438, and program data 439. A user of the computer system 420 may enter commands and information using keyboard 440, mouse 442, or any other input device known to those of ordinary skill in the art, such as, but not limited to, a microphone, controller, scanner, etc. Such input devices typically plug into the computer system 420 through a serial port 446, which in turn is connected to the system bus. Input devices may be also be connected in other ways, such as, without limitation, via a parallel port, a game port, or a universal serial bus (USB). A monitor 447 or other type of display device may also be connected to the system bus 423 across an interface, such as a video adapter 448. In addition to the monitor 447, the computer system may be equipped with other peripheral output devices (not shown), such as loudspeakers, a printer, etc.

Computer system 420 may operate in a network environment, using a network connection to and/or providing a user interface to one or more remote computers 449. The remote computer (or computers) 449 may be local computer workstations or servers comprising most or all of the aforementioned elements in describing the nature of a computer system 420. Other devices may also be present in the computer network, such as, but not limited to, routers, network stations, peer devices or other network nodes. The connections via a network may provide a communication interface that enables the system to receive information from multiple user and to provide medical opinion reports, as described herein, to multiple remote users.

Network connections can form a local-area computer network (LAN) 450 and a wide-area computer network (WAN). Such networks are used in corporate computer networks and internal company networks, and they generally have access to the Internet. In LAN or WAN networks, the computer system 420 is connected to the local-area network 450 across a network adapter or network interface 451. When networks are used, the computer system 420 may employ a modem 454 or other modules that enable communications with a wide-area computer network such as the Internet. The modem 454, which may be an internal or external device, may be connected to the system bus 423 by a serial port 446. The example network connections are non-limiting examples of numerous well-understood ways of establishing a connection by one computer to another using communication modules.

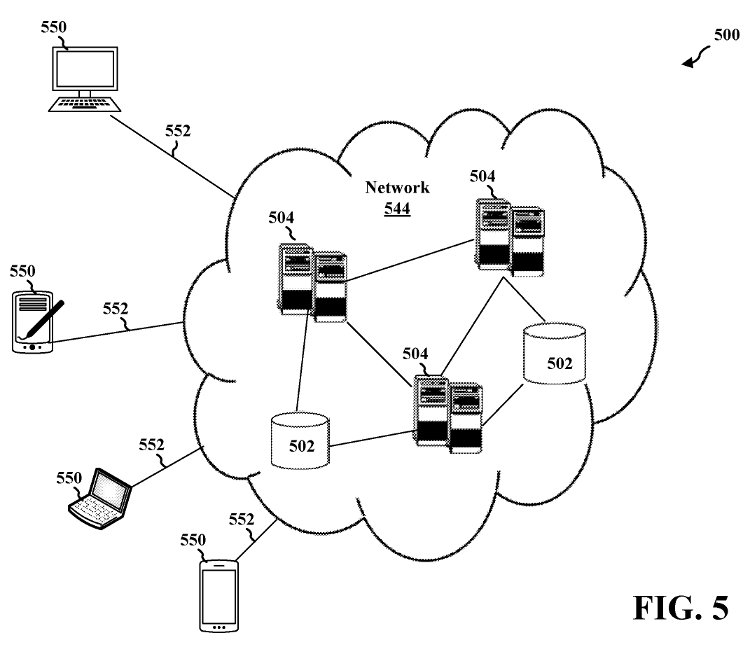

FIG. 5 shows an example communication system 500 usable in connection with aspects described herein for the insurability evaluation system, e.g., as described in connection with any of FIGS. 1-4. The communication system 500 includes one or more accessors (also referred to interchangeably herein as one or more “users,” people, or person) and one or more terminals 550. In one aspect, data for use in accordance aspects presented herein, for example, input and/or accessed by accessors via terminals 550, such as personal computers (PCs), minicomputers, mainframe computers, microcomputers, telephonic devices, or wireless devices, such as personal digital assistants (“PDAs”) or a hand-held wireless devices coupled to one or more servers 504 such as a PC, minicomputer, mainframe computer, microcomputer, or other device having a processor and a repository for data and/or connection to a repository 502 for data, via, for example, a network 544, such as the Internet or an intranet, and couplings 552. The computer system 420 including the insurability evaluation component(s) 475 may be comprised in the network 544, e.g., including one or more servers 504 or data repositories 502. The data repositories may include storage that provides non-volatile, bulk or long term storage of data or instructions in the insurability evaluation system. The storage may take the form of a disk, tape, CD, DVD, or other reasonably high capacity addressable or serial storage medium. Multiple storage devices may be provided or available, and some include network storage or cloud-based storage.

The couplings 552 may include, for example, wired, wireless, or fiberoptic links. For example, the couplings may be part of a communications interface with the insurability evaluation system. Such a communication interface allows software and data to be transferred between the insurability evaluation system and external devices, e.g., 550. Examples of communications interfaces may include a modem, a network interface (such as an Ethernet card), a communications port, a Personal Computer Memory Card International Association (PCMCIA) slot and card, etc. Software and data transferred via communications interface can be in the form of signals , which may be electronic, electromagnetic, optical or other signals capable of being received by the communications interface. These signals may be provided to communications interface via a communications path (e.g., channel). This path carries signals and may be implemented using wire or cable, fiber optics, a telephone line, a cellular link, a radio frequency (RF) link and/or other communications channels.

In another aspect, the methods and system presented herein may operate in a stand-alone environment, such as on a single terminal.

In various aspects, the systems and methods described herein may be implemented in hardware, software, firmware, or any combination thereof. Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure can be addressed in terms of modules. The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module’s functionality, which (while being executed) transform the microprocessor system into a special-purpose device. A module, element, or component may also be implemented as a combination of the two, with particular functions facilitated by hardware alone, and other functions facilitated by a combination of hardware and software. In particular implementations, at least a portion, and in some cases, all, of a module, element, or component may be executed on one or more processors of a general purpose computer. Accordingly, each module may be realized in a variety of suitable configurations, and should not be limited to any particular implementation or example herein. An element, or any portion of an element, or any combination of elements may be implemented as a “processing system” that includes one or more processors. When multiple processors are implemented, the multiple processors may perform the functions individually or in combination. One or more processors in a processing system may execute stored instructions, which may be referred to as software, firmware, middleware, microcode, hardware description language, or otherwise,e.g., instructions, instruction sets, code, code segments, program code, programs, subprograms, software components, applications, software applications, software packages, routines, subroutines, objects, executables, threads of execution, procedures, functions, or any combination thereof.

As used herein, the term “applicant” refers to an individual, or person, for which an analysis is assessed relating to an insurance product.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

A component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents. In the interest of clarity, not all of the routine features of the aspects are disclosed herein. It would be appreciated that in the development of any actual implementation of the present disclosure, numerous implementation-specific decisions must be made in order to achieve the developer’s specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory / memory module may be referred to as memory circuitry.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

In example 1, a method for evaluating insurability of an individual comprises acquiring medical records and real-time health data, generating adaptive questionnaires, analyzing data using an AI model, and reporting a risk score and personalized wellness plan.

In example 2, the method of example 1 further comprises integrating with a genomic database for personalized risk adjustment.

In example 3, the method of example 1 or example 2, wherein the AI model uses machine learning algorithms trained on a dataset of anonymized insurance outcomes and medical records.

In example 4, the method of any of examples 1-3, wherein individuals classified as high-risk are routed to alternate insurers or reinsurance providers.

In example 5, the method of any of examples 1-4, wherein real-time wearable data is continuously streamed to reassess the risk score dynamically.

In example 6, the method of any of examples 1-5 further comprises reporting a wellness recommendation engine that generates risk-reduction strategies based on real-time and historical data.

In example 7, the method of any of examples 1-6 further comprises generating a personalized risk mitigation plan based on ongoing health monitoring data, questionnaire responses, and evolving medical insights.

In example 8, a system for evaluating insurability comprises a communication interface to provide a user interface to one or more users, an AI engine for data analysis, a questionnaire module, a wearable data collector, and a stakeholder dashboard to view dynamic risk profiles.

In example 9, the system of example 8 further comprises a digital twin simulation module that is configured to model future insurability scenarios based on hypothetical user behavior modifications, wherein the simulation engine provides real-time feedback and projected insurability shifts based on inputted or observed lifestyle changes.

In example 10, the system of example 8 or example 9 further comprises a cross-carrier rules engine that enables comparison of insurability across multiple insurance carriers.

In example 11, the system of any of examples 8-10, wherein the dashboard enables interaction between insurers, brokers, and applicants in real-time.

In example 12, the system of any of examples 8-11 further includes a risk diversion module configured to automatically identify and reroute high-risk applicants to alternate underwriting entities.

In example 13, a system for evaluating insurability and dynamically update risk classification based on continuously received real-time health data comprises a communication interface configured to communicatively couple with one or more wearable devices and one or more insurance carrier systems, a data pre-processing module configured to receive medical records via the communication interface and to convert unstructured medical records into structured feature vectors using natural language processing, a questionnaire module configured to generate adaptive questionnaires that are dynamically modified based on the structured feature vectors and prior questionnaire responses, a wearable data collector configured to continuously receive real-time health data streams from the one or more wearable devices via the communication interface, an artificial intelligence engine comprising a trained neural network configured to analyze the structured feature vectors, the questionnaire responses, and the real-time health data streams to generate a risk classification, wherein the trained neural network dynamically updates the risk classification based on the continuously received real-time health data streams, a risk diversion module configured to, in response to the risk classification indicating a high-risk status, automatically generate and transmit routing signals to the one or more insurance carrier systems via the communication interface to route an applicant to an alternate underwriting entity, and a stakeholder dashboard configured to display dynamic risk profiles that are updated in real-time based on the risk classification.

In example 14, the system of example 13 further comprises a digital twin simulation module configured to model future insurability scenarios based on hypothetical user behavior modifications, wherein the digital twin simulation module generates projected risk classifications based on simulated lifestyle changes and outputs the projected risk classifications to the stakeholder dashboard.

In example 15, the system of example 13 or example 14 further comprises a cross-insurance carrier rules engine configured to apply insurance carrier-specific underwriting rules to the risk classification and to generate a comparison of insurability assessments across a plurality of insurance carriers.

In example 16, the system of any of examples 13-15, wherein the stakeholder dashboard is configured to enable real-time interaction between insurers, brokers, and applicants, and to display updates to the risk classification as the real-time health data streams are received.

In example 17, the system of any of examples 13-16, wherein the routing signals comprise application programming interface calls that automatically initiate an underwriting workflow at the alternate underwriting entity.

In example 18, the system of any of examples 13-17, wherein the wearable data collector is configured to compare the real-time health data streams against predefined threshold values and to trigger the artificial intelligence engine to recalculate the risk classification when the real-time health data streams exceed the predefined threshold values.

In example 19, the system of any of examples 13-18 further comprises a wellness recommendation module configured to generate risk-reduction strategies based on the risk classification and the real-time health data streams and to transmit the risk-reduction strategies to a user device associated with an applicant.

In example 20, the system of any of examples 13-19 further comprises a training module configured to receive insurance outcome feedback from the one or more insurance carrier systems and to update parameters of the trained neural network based on the insurance outcome feedback.

In example 21, the system of any of examples 13-20, wherein the data pre-processing module is further configured to tokenize unstructured medical text and to apply named entity recognition to extract medical conditions, medications, and procedures from the medical records.

In example 22, a computer-implemented method for evaluating insurability of an individual comprises acquiring, by processing circuitry, medical records and real-time health data from one or more wearable devices communicatively coupled to the processing circuitry, preprocessing, by the processing circuitry, the medical records using natural language processing to extract structured data fields from unstructured medical text and to generate feature vectors representing health metrics, generating, by the processing circuitry, adaptive questionnaires that are dynamically modified based on the extracted structured data fields and prior questionnaire responses, analyzing, by the processing circuitry, the feature vectors and questionnaire responses using a trained artificial intelligence model comprising a neural network trained on a dataset of anonymized insurance outcomes and medical records, wherein the trained artificial intelligence model generates embedding vectors from the health metrics and outputs a risk classification, continuously streaming, by the processing circuitry, the real-time health data from the one or more wearable devices and dynamically updating the risk classification based on the streamed real-time health data, and in response to the risk classification indicating a high-risk status, automatically transmitting, by the processing circuitry, routing instructions to one or more insurance carrier systems to route the individual to an alternate insurer or reinsurance provider.

In example 23, the method of example 22 further comprises integrating with a genomic database to retrieve genomic risk markers associated with the individual, and adjusting the risk classification based on the retrieved genomic risk markers.

In example 24, the method of example 22 or example 23, wherein training the trained artificial intelligence model comprises applying backpropagation and gradient descent optimization on the dataset of anonymized insurance outcomes and medical records to minimize a loss function.

In example 25, the method of any of examples 22-24, wherein preprocessing the medical records further comprises tokenizing the unstructured medical text and applying named entity recognition to identify medical conditions, medications, and procedures.

In example 26, the method of any of examples 22-25, wherein dynamically updating the risk classification comprises comparing the streamed real-time health data against predefined threshold values and triggering a recalculation of the risk classification when the streamed real-time health data exceeds the predefined threshold values.

In example 27, the method of any of examples 22-26 further comprises generating, by the processing circuitry, a personalized wellness plan based on the risk classification and the real-time health data, and transmitting the personalized wellness plan to a user device associated with the individual.

In example 28, the method of any of examples 22-27 further comprises receiving feedback data from the one or more insurance carrier systems indicating insurance outcomes for previously evaluated individuals, and updating parameters of the trained artificial intelligence model based on the received feedback data.

In example 29, the method of any of examples 22-28, wherein the routing instructions comprise application programming interface calls to the one or more insurance carrier systems that automatically initiate an underwriting workflow at the alternate insurer or reinsurance provider.

In example 30, the method of any of examples 22-29, wherein the one or more wearable devices comprise at least one of a heart rate monitor, a blood pressure monitor, or an activity tracker, and wherein the real-time health data comprises at least one of heart rate data, blood pressure data, or activity level data.

In example 31, a non-transitory computer-readable storage medium storing instructions that, when executed by processing circuitry, cause the processing circuitry to perform operations of the method of any of examples 22-30.

What is claimed is:

1. A system for evaluating insurability and dynamically update risk classification based on continuously received real-time health data, comprising:
a communication interface configured to communicatively couple with one or more wearable devices and one or more insurance carrier systems;
a data pre-processing module configured to receive medical records via the communication interface and to convert unstructured medical records into structured feature vectors using natural language processing;
a questionnaire module configured to generate adaptive questionnaires that are dynamically modified based on the structured feature vectors and prior questionnaire responses;
a wearable data collector configured to continuously receive real-time health data streams from the one or more wearable devices via the communication interface;
an artificial intelligence engine comprising a trained neural network configured to analyze the structured feature vectors, the questionnaire responses, and the real-time health data streams to generate the risk classification, wherein the trained neural network dynamically updates the risk classification based on the continuously received real-time health data streams;
a risk diversion module configured to, in response to the risk classification indicating a high-risk status, automatically generate and transmit routing signals to the one or more insurance carrier systems via the communication interface to route an applicant to an alternate underwriting entity; and
a stakeholder dashboard configured to display dynamic risk profiles that are updated in real-time based on the risk classification.

2. The system of claim 1, further comprising:
digital twin simulation module configured to model future insurability scenarios based on hypothetical user behavior modifications, wherein the digital twin simulation module generates projected risk classifications based on simulated lifestyle changes and outputs the projected risk classifications to the stakeholder dashboard.

3. The system of claim 1, further comprising:
a cross-insurance carrier rules engine configured to apply insurance carrier-specific underwriting rules to the risk classification and to generate a comparison of insurability assessments across a plurality of insurance carriers.

4. The system of claim 1, wherein the stakeholder dashboard is configured to enable real-time interaction between insurers, brokers, and applicants, and to display updates to the risk classification as the real-time health data streams are received.

5. The system of claim 1, wherein the routing signals comprise application programming interface calls that automatically initiate an underwriting workflow at the alternate underwriting entity.

6. The system of claim 1, wherein the wearable data collector is configured to compare the real-time health data streams against predefined threshold values and to trigger the artificial intelligence engine to recalculate the risk classification when the real-time health data streams exceed the predefined threshold values.

7. The system of claim 1, further comprising:
a wellness recommendation module configured to generate risk-reduction strategies based on the risk classification and the real-time health data streams and to transmit the risk-reduction strategies to a user device associated with an applicant.

8. The system of claim 1, further comprising:
a training module configured to receive insurance outcome feedback from the one or more insurance carrier systems and to update parameters of the trained neural network based on the insurance outcome feedback.

9. The system of claim 1, wherein the data pre-processing module is further configured to tokenize unstructured medical text and to apply named entity recognition to extract medical conditions, medications, and procedures from the medical records.

10. A computer-implemented method for evaluating insurability of an individual, the method comprising:
acquiring, by processing circuitry, medical records and real-time health data from one or more wearable devices communicatively coupled to the processing circuitry;
preprocessing, by the processing circuitry, the medical records using natural language processing to extract structured data fields from unstructured medical text and to generate feature vectors representing health metrics;
generating, by the processing circuitry, adaptive questionnaires that are dynamically modified based on the extracted structured data fields and prior questionnaire responses;
analyzing, by the processing circuitry, the feature vectors and questionnaire responses using a trained artificial intelligence model comprising a neural network trained on a dataset of anonymized insurance outcomes and medical records, wherein the trained artificial intelligence model generates embedding vectors from the health metrics and outputs a risk classification;
continuously streaming, by the processing circuitry, the real-time health data from the one or more wearable devices and dynamically updating the risk classification based on the streamed real-time health data; and
in response to the risk classification indicating a high-risk status, automatically transmitting, by the processing circuitry, routing instructions to one or more insurance carrier systems to route the individual to an alternate insurer or reinsurance provider.

11. The method of claim 10, further comprising:
integrating with a genomic database to retrieve genomic risk markers associated with the individual; and
adjusting the risk classification based on the retrieved genomic risk markers.

12. The method of claim 10, wherein training the trained artificial intelligence model comprises applying backpropagation and gradient descent optimization on the dataset of anonymized insurance outcomes and medical records to minimize a loss function.

13. The method of claim 10, wherein preprocessing the medical records further comprises tokenizing the unstructured medical text and applying named entity recognition to identify medical conditions, medications, and procedures.

14. The method of claim 10, wherein dynamically updating the risk classification comprises comparing the streamed real-time health data against predefined threshold values and triggering a recalculation of the risk classification when the streamed real-time health data exceeds the predefined threshold values.

15. The method of claim 10, further comprising:
generating, by the processing circuitry, a personalized wellness plan based on the risk classification and the real-time health data; and
transmitting the personalized wellness plan to a user device associated with the individual.

16. The method of claim 10, further comprising:
receiving feedback data from the one or more insurance carrier systems indicating insurance outcomes for previously evaluated individuals; and
updating parameters of the trained artificial intelligence model based on the received feedback data.

17. The method of claim 10, wherein the routing instructions comprise application programming interface calls to the one or more insurance carrier systems that automatically initiate an underwriting workflow at the alternate insurer or reinsurance provider.

18. The method of claim 10, wherein the one or more wearable devices comprise at least one of a heart rate monitor, a blood pressure monitor, or an activity tracker, and wherein the real-time health data comprises at least one of heart rate data, blood pressure data, or activity level data.

19. A non-transitory computer-readable storage medium storing instructions that, when executed by processing circuitry, cause the processing circuitry to perform operations comprising:
acquiring medical records and real-time health data from one or more wearable devices;
preprocessing the medical records using natural language processing to extract structured data fields from unstructured medical text and to generate feature vectors representing health metrics;
generating adaptive questionnaires that are dynamically modified based on the extracted structured data fields and prior questionnaire responses;
analyzing the feature vectors and questionnaire responses using a trained artificial intelligence model comprising a neural network, wherein the trained artificial intelligence model generates embedding vectors from the health metrics and outputs a risk classification;
continuously streaming the real-time health data from the one or more wearable devices and dynamically updating the risk classification based on the streamed real-time health data; and
in response to the risk classification indicating a high-risk status, automatically transmitting routing instructions to one or more insurance carrier systems to route an individual to an alternate insurer or reinsurance provider.

20. The non-transitory computer-readable storage medium of claim 19, wherein the operations further comprise:
receiving feedback data from the one or more insurance carrier systems indicating insurance outcomes; and
updating parameters of the trained artificial intelligence model based on the received feedback data.
